(19) United States
(12) Patent Application Publication
(10) Pub. No.: US 2007/0226119 A1
(43) Pub. Date: Sep. 27, 2007

(54) Online valuation and trading of digital media

(76) Inventors: Robert Jonathan Balser, Atlanta, GA (US); Michael Bevil, Atlanta, GA (US)

Correspondence Address: MCKENNA LONG & ALDRIDGE LLP, 1900 K STREET, NW, WASHINGTON, DC, 20006, US

(21) Appl. No.: 11/384,445

(22) Filed: Mar. 21, 2006

(51) Int. Cl. G06Q 40/00

(52) U.S. Cl. 705/37

(57) ABSTRACT

An online valuation and trading system for commodities, such as digital media, assigns objective trading or economic values to commodities to facilitate fair trades and trading. Entities accessing or logging onto the site input information pertaining to commodities to be surrendered and acquired. Based upon the information, the online valuation and trading system is configured to provide entities with an objective valuation and appraisal of their respective commodities during a trading period or an appointed period in time according to relevant and dynamic factors or criteria, such as internal/external supply and demand. The online valuation and trading system includes a forum that promotes trading and/or negotiating with respect to an objective value by identifying potential trading partners and recommending desirable trades.

### BACKGROUND OF THE INVENTION

1. Field of the Invention

The present invention relates to online trading systems, particularly to an online system for valuating and trading commodities, such as digital media.

2. Discussion of the Related Art

The consumer media market is rapidly expanding with advances in consumer electronics, such as digital video recorders, gaming systems, and personal computers. The digital media market, which includes, for example, DVDs, music CDs, and electronic games, continues to increase each year. As a result, consumers tend to treat digital media as having little or no value after viewing, playing, or using the media several times even though these digital media are in relatively good condition and have market value. Also, there is a tendency for consumers to desire other digital media after they have viewed, played, or used their digital media several times. For instance, upon completing or mastering an electronic game, a consumer may want to obtain and play another electronic game. Accordingly, based on at least the foregoing examples, there is a need for a trading and valuation system that will allow consumers to receive or even recoup maximum and fair value for their commodities based upon an objective valuation so that they may be presented with or negotiate fair trades.

Related art in this field include various websites that allow individuals to sell items that they no longer want and/or use. For example, Ebay.com provides a portal for online auctions and/or virtual stores which allow individuals to buy and sell items. In addition, there are other websites, such as SwapandSave.com, YesSwap.com, Spun.com, TheGameTrader.com, and peerflix.com., which allow individuals to trade their used media with others or obtain credit against media purchased from the site. However, these websites are limited to providing an individual with a listing of media that are to be traded and media that are desired to be received.

Accordingly, there is a need for a system and a method that would allow individuals to obtain fair and objective valuation of their commodities, as well as an engine capable of facilitating such transactions.

### SUMMARY OF THE INVENTION

The present invention provides an online system and method for trading commodities, such as digital media, that substantially obviates the limitations and disadvantages of the related art.

An advantage of the present invention is that it provides an objective economic or trading value for commodities to be traded and allows potential trading partners to establish fair trades based upon the objective value.

The present invention advantageously provides an objective valuation of commodities during a trading period and/or an appointed period based upon relevant and dynamic factors or criteria, which are updated to reflect the market at that particular point or period in time.

Another advantage of the present invention is that it identifies and proposes objective trades and potential trading partners. In addition, the present invention is advantageously configured to provide an entity accessing or using the online trading system with relevant information, such as consumer feedback regarding potential trading partners and notification options regarding trades.

Additional features and advantages of the invention will be set forth in the description that follows, and in part will be apparent from the description, or may be learned by practice of the invention. The objectives and other advantages of the invention will be realized and attained, as particularly pointed out in the written description and claims hereof, as well as the appended drawings.

To achieve these and other advantages and in accordance with the purpose of the present invention, as embodied and broadly described, a method includes receiving information regarding digital media to be surrendered, receiving information regarding digital media to be acquired, generating a value for a digital media based on at least supply and demand, and generating a list of potential trading partners and at least one proposed trade associated with each potential partner based on the value.

In another aspect of the present invention, a method includes receiving information regarding digital media to be surrendered, receiving information regarding digital media to be acquired, determining internal demand of a particular digital media title based on an amount of a particular digital media title that is desired to be acquired via the online system, determining internal supply of the particular digital media title based on an amount of the particular digital media title that is desired to be surrendered via the online system, and generating a value for the particular media title based on the internal demand, the internal supply, as well as other factors associated with the particular digital media title.

It is to be understood that both the foregoing general description and the following detailed description are exemplary and are intended to provide further explanation of the present invention.

### BRIEF DESCRIPTION OF THE DRAWINGS

The accompanying drawings, which are included to provide a further understanding of the invention and are incorporated in and constitute a part of this specification, illustrate embodiments of the invention and serve to explain the principles of the present invention together with the description.

In the drawings:

FIG. 1 is a flowchart illustrating a trading forum according to an embodiment of the present invention;

FIG. 2 is a flowchart illustrating a trade according to an embodiment of the present invention; and

FIG. 3 is a flowchart illustrating a trading or economic valuing process according to an embodiment of the present invention.

### DETAILED DESCRIPTION OF THE INVENTION

Reference will now be made in detail to embodiments of the present invention, examples of which are illustrated in the accompanying drawings.

The present invention provides an online system and method for trading or exchanging commodities, such as digital media. For exemplary and illustrative purposes, the present invention is described herein in terms of trading video games, such as Microsoft XBox, Sony Playstation 2, Nintendo GameCube and Nintendo GameBoy Advance gaming software titles. However, the present invention can be applied to any form, presentation, storage, or transfer of digital media, such as movies on DVD, music on CD, compressed/non-compressed images, and the authorized downloading or sharing of files and/or software.

The online trading system assigns an objective trading value to each media title. The trading value is presented for evaluation via the online system, e-mail, or any other electronic manner. This trading value provides a market value for a particular media title with respect to at least one of a trading period and an appointed point in time.

The trading value is calculated or determined based on several relevant and dynamic factors, such as information pertaining to supply and demand. This information may be “internal” to the online valuation and trading system and/or may be “external” to the online valuation and trading system. For example, the supply and demand information may pertain to at least one of internal supply, internal demand, external supply, and external demand. Internal supply refers to the number of copies of a particular media title that is available for trade via the online valuation and trading system. Internal supply may be denoted by or may correspond to the number of entities, accessing the online valuation and trading system, that wish to surrender a particular title. Internal demand refers to the number of copies of a particular media title that is desired to be acquired via the online valuation and trading system. Internal demand may be denoted by or may correspond to the number of entities, accessing the online valuation and trading system, that wish to acquire a particular media title. External supply may refer to the number of copies of a particular media title that is generally available on the market. External supply does not include the number of copies of a particular media title associated with internal supply. External demand may refer to a quantitative representation of the demand of a particular media title or a general representation of the level of demand (e.g., low, medium, or high) of a particular media title. External demand may exclude the number of copies of a particular media title associated with internal demand. Information relating to external demand may include information that is relevant to assigning value to the title, such as the lowest used price currently available, the cumulative game ranking, the cost to purchase the title new, and the like.

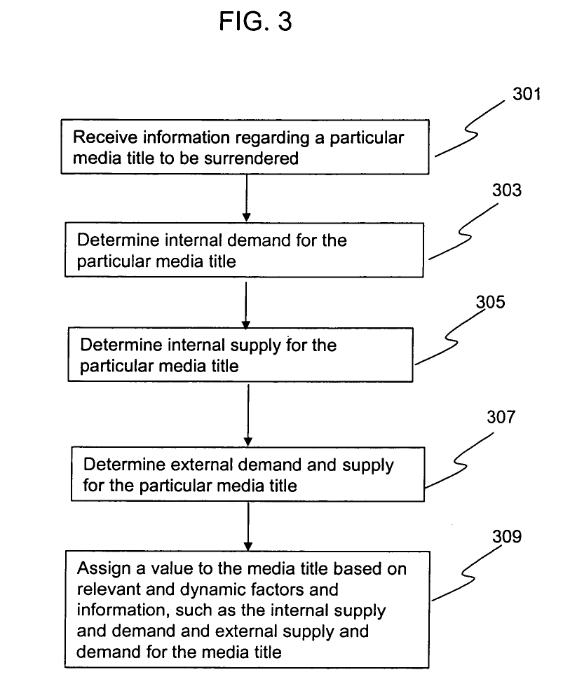

As illustrated in FIG. 3, the economic valuing process begins with a “visitor.” A “visitor” refers to any entity accessing or logging onto the online valuation and trading system or site. The visitor is requested to list titles and/or any product identification data (e.g., serial numbers) regarding the digital media that is desired to be surrendered and/or acquired. The visitor provides information regarding the title, such as the condition of a game to be surrendered, step 301. The condition information may include information such as the condition of the box, whether or not the instructions are included and the like. At step 303, information regarding the internal demand for the particular game is retrieved. For example, the number of visitors, who wish to acquire the particular title may be retrieved from an internal database. At step 305, information regarding the supply of the game is retrieved. For example, the number of visitors willing to surrender the particular game may be retrieved from an internal database. Information regarding external demand and external supply, if applicable, is retrieved at step 307. For example, the system may access or receive information from external databases, such as the lowest used price for a game, the game's ranking, and the like. Optionally, the system is configured to access and retrieve other criteria and information that is relevant to determining the trading value of the game.

The relevant information may include dynamic or static factors directly or indirectly relating to or affecting at least one of internal supply, internal demand, external supply, and external demand. For example, dynamic factors may include information that reflects and relates to a given time period, such as the age of the game, the popularity (e.g., supply and demand) of the game, and other related data. Static or fixed factors may include information, such as the number of games on the market if a particular game has been discontinued, the ranking of a particular game by a particular magazine with respect to a particular year, the original market value or asking price of the game, and other like information.

The online valuation and trading system is configured to determine an objective trading or economic value based upon a dynamic valuation algorithm or system. The valuation algorithm may include at least one of a weighting scheme, a prioritizing scheme, a selection or determination scheme, and any other methods associated with determining an objective value of a commodity based upon various factors and/or sources of information. The valuation algorithm is dynamic and is subject to change based on a number of factors, such as the type of information that is provided, retrieved, or available for a particular media title. Also, the valuation algorithm may change based on modifications that are made to enhance or amplify the online valuation and trading system. Based upon the valuation algorithm or system, a trading value is assigned to the game according to the retrieved information (step 309).

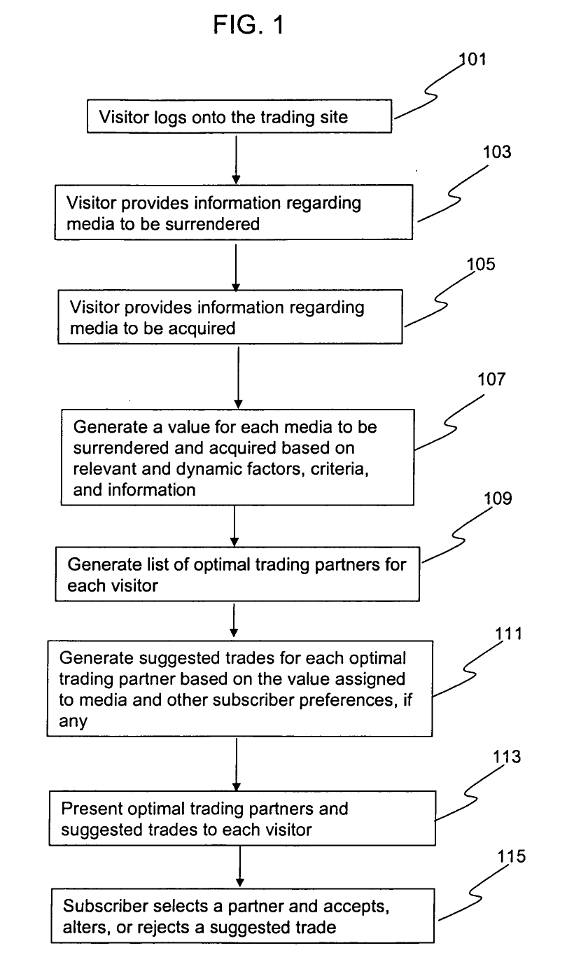

The trading value is used to allow a subscriber to evaluate potential trades and offer trades to other subscribers. FIG. 1 illustrates a flow chart for the online valuation and trading system according to an exemplary embodiment of the invention. As shown in FIG. 1, the process begins with a visitor, which refers to any entity accessing or logging onto the trading site, such as a subscriber or a non-subscriber (step 101).

Visitors provide information regarding games the visitors wish to surrender (step 103). This information may include, for example, the title of the game, the product identification number, the condition of the game, whether or not instructions are available, and the condition of the box. After information regarding the games to be surrendered has been entered, the visitor is prompted to enter information regarding games the visitor wishes to acquire (step 105). This information may include the title of the game, the product identification number, the desired condition, the minimum acceptable condition and the like.

An interactive graphical user interface including an intuitive PC wizard-like prompt may be utilized to guide visitors through the process. The prompt may request the entity to provide information regarding each game, such as the game condition and whether the manual and the original packaging are being provided. The site is adapted to encourage visitors to add additional games to their want list based on games they previously requested. The site is also configured to allow visitors to browse or search the online valuation and trading system for a listing of games that other entities are willing to surrender (i.e., digital media titles that are available) to assist visitors in creating or modifying their want list. The site may also include other features, such as a window that tracks and displays status information regarding trades or the trading process.

After the visitors have provided information regarding the games to be surrendered and the games to be acquired, the system assigns a value to each game as soon as the game is listed or upon receiving, processing, and retrieving any necessary information (step 107), as discussed above with reference to FIG. 3.

Once this information is provided, the system generates and presents to the visitor a list of other gamers (potential trading partners) who have the games that the visitor desires and who want the games that the visitor is surrendering (step 109). This list can be sorted by many criteria, such as user ranking, number of trade matches (number of games each gamer has that the other wants), number of trades already made with each individual, whether that gamer is currently online for “live trading”, or a combination of some or all of these factors.

The system is configured to permit the visitor to click on any one of the garners on the list for a more detailed view of the potential trade partner to help determine if a trade is appealing or not. This detailed view may include a list of each gamers' full game library including an indication of which games are desired by at least one other visitor, as well as a list of suggested “fair” trades generated by the system (step 111). The list of suggested fair trades may be based on the value assigned to games by the system. Multiple trade options may be presented to the visitor, who may choose to accept, alter, reject, or simply ignore any of the suggested trades and create their own trade (step 115).

Once a visitor that is a non-subscriber becomes a subscriber, he/she may then offer any one of the suggested or self-designated trades to other subscribers, who may accept, alter, or reject the offered trade. The trades are presented to other subscribers via the online valuation and trading system, e-mail, or any type or combination of different types of communication technology.

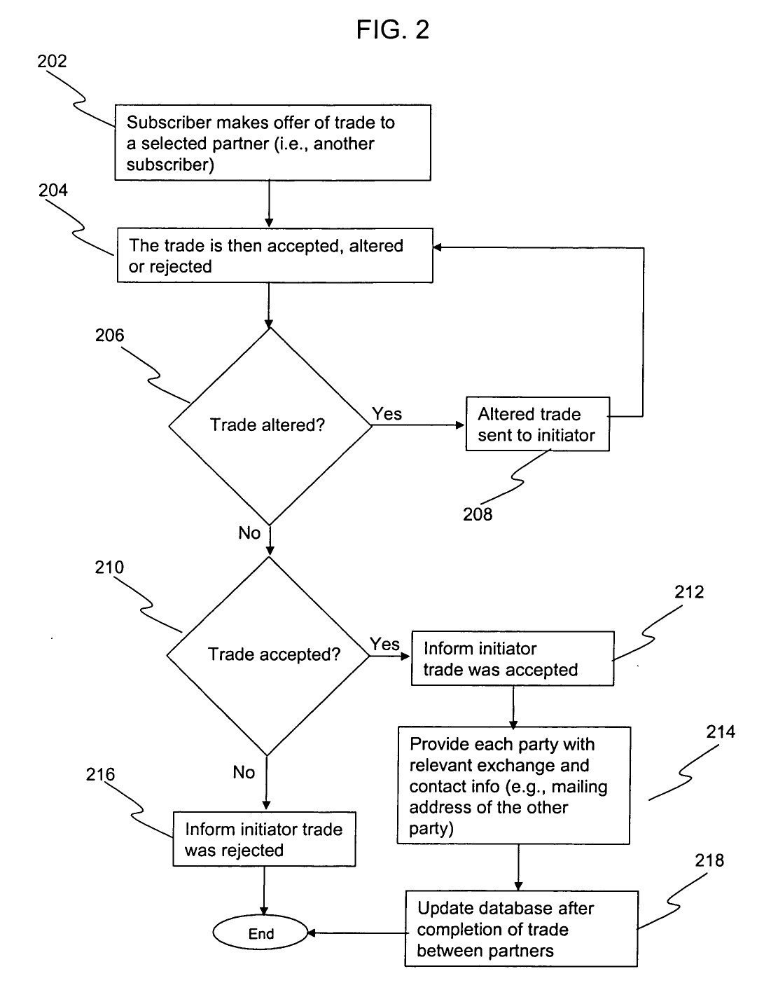

FIG. 2 illustrates a trade according to an exemplary embodiment of the present invention. As shown in FIG. 2, a subscriber makes an offer for trade to a selected partner at step 202. The trade is then accepted, altered or rejected by the selected partner (step 204). If the trade is altered by the selected partner (Yes path out of step 206), the new version of the trade is sent back to the original gamer (step 208). The altered trade may then be accepted, altered or rejected. (This continues until an offer is rejected or accepted.)

If the offer is accepted (Yes path out of step 210), the initiator of the offer is notified that the trade has been accepted (step 212). Then, both parties receive any information necessary to complete the transaction such as a mailing address of the other party (step 214). In addition, the trade is configured to be added to the “pending trades” section of each subscribers “Home Page”. If the trade is accepted, the status of the trade is updated during the process, such as when a subscriber mails the game(s), receives the game(s) and rates the other subscriber. Once both parties have completed all of transaction requirements, the trade is complete (step 218).

If an offer is rejected (no path out of step 216), the initiator of the trade is notified that the offer has been rejected and the process ends.

During the trading process or upon completion of a trade or transaction, the online valuation and trading system is configured to dynamically update any information pertaining to or related to the valuation or trading of commodities.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of facilitating trading of digital media for an online system, said method comprising:
receiving information regarding digital media to be surrendered;
receiving information regarding digital media to be acquired;
generating a value for a digital media based on at least supply and demand; and
generating a list of potential trading partners and at least one proposed trade associated with each potential partner based on the value.

2. The method according to claim 1, further comprising:
providing information to each trading entity if a proposed trade is accepted.

3. The method according to claim 1, further comprising:
presenting options of accepting, modifying, or rejecting a selected proposed trade.

4. The method of claim 1, wherein the supply is determined based on the number of subscribers that wish to surrender a particular digital media title.

5. The method of claim 1, wherein the supply is determined based on the number of a particular digital media title that is available for trading.

6. The method of claim 1, wherein the demand is determined based on the number of subscribers that wish to acquire a particular digital media title via the online system.

7. The method of claim 1, wherein the demand is determined based on the number of a particular digital media title that is desired to be acquired via the online system.

8. The method of claim 1, wherein the value is generated based on information gathered from sources external to the online system.

9. The method of claim 8, wherein the information includes information relevant to the value of the particular digital media title.

10. The method of claim 7, wherein the information includes a ranking of a particular digital media title.

11. The method of claim 8, wherein the information includes a lowest available price of a particular digital media title.

12. The method of claim 8, wherein the value is determined based on a physical condition of a particular media title.

13. The method of claim 8, wherein the value is determined based on data indicating a variation of a current condition of a particular media title from an original condition of the particular media title.

14. A method of assigning value to digital media for an online system, said method comprising:
receiving information regarding digital media to be surrendered;
receiving information regarding digital media to be acquired;
determining internal demand of a particular digital media title based on an amount of a particular digital media title that is desired to be acquired via the online system;
determining internal supply of the particular digital media title based on an amount of the particular digital media title that is desired to be surrendered via the online system; and
generating a value for the particular media title based on the internal demand, the internal supply, and other factors associated with the particular digital media title.

15. The method of claim 14, wherein the other factors include information relevant to the value of the particular digital media title.

16. The method of claim 14, wherein the other factors include a ranking of the particular digital media title.

17. The method of claim 14, wherein the other factors include a lowest available price associated with the particular digital media title.

18. The method of claim 14, wherein the other factors include data pertaining to a condition of the particular media title.

19. The method of claim 14, wherein the other factors include data pertaining to a resale value of the particular media title.

20. The method of claim 14, wherein the other factors include data indicating a variation of a current condition of the particular media title from an original condition of the particular media title.
